(19) United States
(12) Patent Application Publication
(10) Pub. No.: US 2014/0179296 A1
(43) Pub. Date: Jun. 26, 2014

(54) Over The Air Modification Of The Telephone Number Of A Mobile Unit

(71) Applicant: ALCATEL-LUCENT USA INC., Murray Hill, NJ (US)

(72) Inventors: Yigang Cai, Naperville, IL (US); Gopa Ganguly, New Albany, OH (US)

(21) Appl. No.: 13/722,407

(22) Filed: Dec. 20, 2012

(51) Int. Cl. H04W 8/24

(52) U.S. Cl. CPC H04W 8/24
USPC 455/418

(57) ABSTRACT

The telephone number, such as the MSISDN or MDN, of a mobile unit can be changed with Over the Air (OTA) messaging without replacing the SIM/UICC device or changing the IMSI of the mobile unit. The user of a mobile unit can add or change a telephone number of a mobile unit without having to go to a service center or replace the SIM card of the mobile unit.

### FIELD OF THE INVENTION

The present invention relates generally to communication systems.

### BACKGROUND OF THE INVENTION

Mobile phones typically include a subscriber identity module or subscriber identification module (SIM) embedded in a removable SIM card. SIMs are integrated circuits that securely store identification and authentication information for mobile telephony devices, such as mobile phones and computers.

An International Mobile Subscriber Identity (IMSI) is a unique identification associated with all GSM, UMTS and LTE network SIM cards.

Mobile phones also typically include a telephone number that can be dialed to request a call with the mobile phone. For example, the telephone number may be an MSISDN (Mobile Subscriber Integrated Services Digital Network-Number) or an MDN (Mobile Directory Number). These numbers are used to route calls to a mobile phone. A SIM is typically uniquely associated to an IMSI, while the MSISDN or MDN can change over time, for example when utilizing number portability.

In current communication systems, if a user wants to change the telephone number of their mobile phone, the user must go to a service center of their cellular provider and have a technician physically connect their mobile phone to the provision system and have the telephone number manually modified on the SIM card of the mobile phone.

Having to drive to a service center to have a phone number modified is time wasting and inefficient.

Therefore, a need exists for a way of modifying or adding a telephone number to a mobile phone without having to drive to a service center of the cellular service provider.

### BRIEF SUMMARY OF THE INVENTION

An exemplary embodiment of the present invention proposes a method, system, and apparatus that allows the telephone number, such as the MSISDN or MDN, of a device, such as a mobile unit, to be changed with Over the Air (OTA) messaging without replacing the SIM/UICC device or changing the IMSI of the mobile unit. Therefore the user of a mobile unit can add or change a telephone number of a mobile unit without having to go to a service center or replace the SIM card of the mobile unit.

An exemplary embodiment allows a service provider to change the telephone number, such as the MSISDN/MDN, of a mobile unit using over the air procedures. The subscriber with the mobile unit does not need to go to operator's service center to change their telephone number to a new telephone number. Additionally, an exemplary embodiment allows for retries in the case of failure. Further, an exemplary embodiment provides uninterrupted service during the new telephone number acquisition process.

An exemplary embodiment can be utilized to provision a mobile unit with an additional telephone number. In this embodiment, the original telephone number is preferably not flagged as temporary in the HSS/HLR database.

### BRIEF DESCRIPTION OF THE SEVERAL VIEWS OF THE DRAWINGS

FIG. 1 depicts the functional architectural of a communication network in accordance with an exemplary embodiment of the present invention.

FIG. 2 depicts a call flow diagram in accordance with an exemplary embodiment of the present invention.

### DETAILED DESCRIPTION OF THE INVENTION

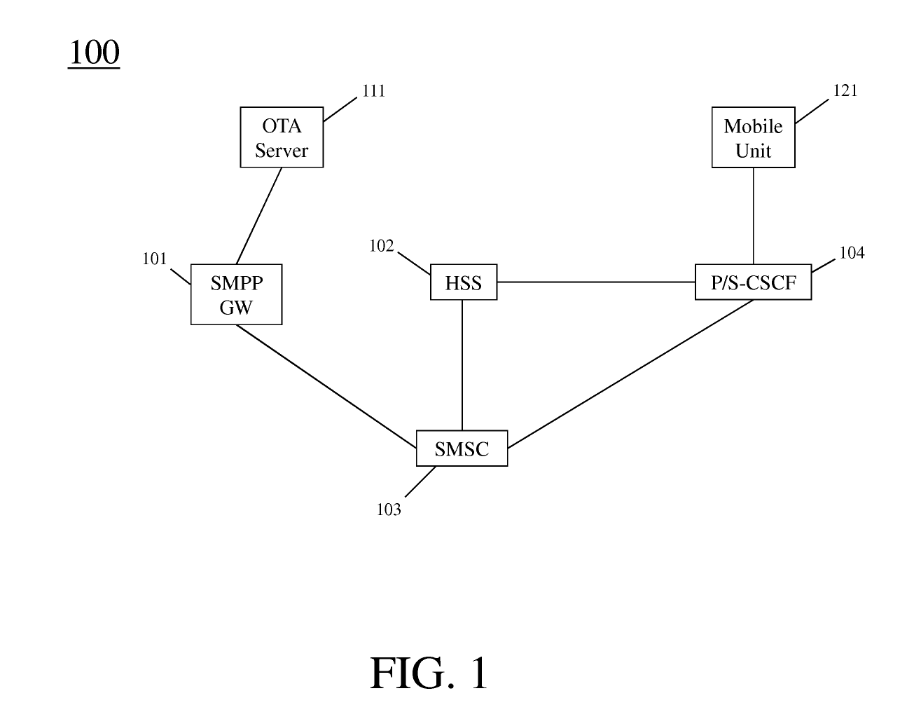

FIG. 1 depicts the functional architectural of communication network 100 in accordance with an exemplary embodiment of the present invention. Network 100 preferably includes Short Message Peer-to-Peer (SMPP) Gateway 101, Home Subscriber Server (HSS) 102, Short Message Service Center (SMSC) 103, Proxy/Serving Call State Control Function (P/S-CSCF) 104, and Over The Air (OTA) Server 111. Mobile unit 121 is a mobile unit that can communicate with network 100. Network 100 depicted in FIG. 1 is an IMS network, but network 100 can alternately be any suitable wireless network, such as but not limited to an LTE network, a CDMA network, or a GSM network.

SMPP Gateway 101 is a gateway that utilizes the SMPP protocol for exchanging SMS messages between SMS peer entities, such as OTA server 111 and SMSC 103.

Home Subscriber Server (HSS) 102 is a master user database that supports the IMS network entities that actually handle calls. HSS 102 preferably includes subscriber profiles and performs authentication and authorization of the user. HSS 102 can also provide information about the subscriber's location and IP information.

In accordance with an exemplary embodiment, HSS 102 supports multiple PUID. In an alternate exemplary embodiment, in the case where HSS 102 is an HLR, the HLR supports IMSI.

In accordance with an exemplary embodiment, HSS 102 creates and maintains a mapping table of old and new MSISDN/MDN per IMSI. The mapping table is preferably temporary. The mapping table preferably includes an indication on old and new telephone numbers. Alternately the mapping table creates a record for the new MSISDN/MDN that uses the same IMSI, and points to the old MDN. HSS 102 preferably sets up an expiration time of old MSISDN/MDN per IMSI.

HSS 102 preferably removes the old MSISDN/MDN per IMSI when either timer expires. HSS 102 can also remove the old MSISDN/MDN per IMSI on receiving a confirmation from OTA server 111 for successful installation of a new MSISDN/MDN at mobile unit 121. Alternately, HSS 102 can remove the old MSISDN/MDN per IMSI on receiving a registration request with the new MSISDN/MDN when the new MSISDN/MDN has flagged the old number as temporary. In either scenario, deleting the old MSISDN/MDN number may be delayed until updates to the network address books, etc., are completed. Alternately, a mapping from the old telephone number to the new telephone number may be retained in the system for a period of time, for example a few days, to allow automated announcements of the number change to be played.

SMSC 103 is a network element that delivers SMS messages. In accordance with an exemplary embodiment, SMSC 103 identifies the destination address string as an IMSI per destination TON/NPI. SMSC 103 preferably queries HSS 102 to obtain the routing information of mobile unit 121. SMSC 103 preferably uses the IMSI and proprietary TON/NPI of mobile unit 121 when querying. HSS 102 preferably returns a response with a device routing address associated to the IMSI of mobile unit 121.

SMSC 103 preferably delivers the OTA SMS to mobile unit 121 using the routing data received from HSS 102. SMSC 103 preferably converts the OTA SMS from OTA Server 111 to the appropriate protocol for the destination network, for example MAP in GSM, SMDPP in CDMA, SIP in IMS, SIP or Diameter in LTE network. SMSC 103 preferably includes the appropriate address of mobile unit 121 in the destination address field. In an exemplary embodiment, the address is the IMSI of mobile unit 121. In an alternate exemplary embodiment, the address is the old MSISDN/MDN. SMSC 103 can include a mapping of the old telephone number to the new telephone number for mobile unit 121 in its local database.

P/S-CSCF 104 can be a Proxy-CSCF (P-CSCF) or a Serving-CSCF (S-CSCF). A P-CSCF is a SIP proxy that is preferably the first point of contact for an IMS terminal. A P-CSCF preferably sits on the path of all signaling messages and can inspect every signal. A P-CSCF preferably provides subscriber authentication, and inspects the signaling and ensures that the IMS terminals act in accordance with network policies.

An S-CSCF is the central node of the signaling plane. An S-CSCF is a SIP server that preferably also performs session control. An S-CSCF is preferably located in the home network and uses Diameter Cx or Dx interfaces to HSS 102 to download user profiles and upload user-to-S-CSCF associations. All necessary subscriber profile information is preferably loaded from HSS 102. The S-CSCF preferably handles SIP registrations, which allows the S-CSCF to connect the user location, such as the IP address of the terminal, and the SIP address of the terminal. The S-CSCF preferably sits on the path of all signaling messages of the locally registered users, and can inspect every message. An S-CSCF preferably determines which application servers to forward SIP messages to and also provides routing services, typically using Electronic Numbering (ENUM) lookups. It should be understood that there can be multiple S-CSCFs in communication network 100 for load distribution and high availability reasons.

OTA Server 111 is a server that allows for the transmission and reception of application-related information, such as Short Messaging Service (SMS) messages, in wireless communications network 100.

In accordance with an exemplary embodiment, the operator's provisioning system sends a notification to OTA server 111 after updating mobile unit 121 with a new telephone number in the network system elements. The notification preferably informs OTA server 111 to execute a change MSISDN/MDN command message to mobile unit 121, which preferably includes the IMSI of mobile unit 121 and the new telephone number, and optionally can include the old telephone number of mobile unit 121.

In an alternate exemplary embodiment, OTA server 111 uses an interface to initiate creation of the record for the new-MSISDN/MDN on HSS/HLR 102. A successful return code from HSS/HLR 102 preferably triggers the sending of the OTA command.

OTA server 111 preferably embeds the new MSISDN/MDN command in the user data (UD) PDU in a SMPP SMS, with a destination address using an IMSI string, and a destination TON/NPI to indicate the destination address is a type of IMSI. Optionally, OTA server 111 constructs SMPP SMS using old MSISDN/MDN as the destination address. OTA server 111 preferably sets up a unique message ID in the OTA SMS in order to assist for correlation purposes. The OTA SMS may request a delivery receipt, preferably in SMPP, for mobile unit 121 to send a proof of the installation of a new number.

OTA server 111 expects to receive a proof of execution in a mobile originated SMS from mobile unit 121. Mobile unit 121 can use the IMSI, the old telephone number, or the new telephone number as the originating address. In an exemplary embodiment, the message ID is the same as the one in the OTA SMS that mobile unit 121 received from OTA server 111. Mobile unit 121 preferably embeds the proof content body in the UD. The proof could indicate a successful or unsuccessful installation of new telephone number. OTA server 111 preferably correlates the proof with previous OTA SMS command using the same message ID.

In accordance with an alternate exemplary embodiment, OTA sever 111 unwraps the proof and processes the data, whether the installation of the new telephone number succeeded or not. OTA server 111 may additionally notify the HSS 102 of the proof data.

Mobile Unit 121 is a wireless communication device that can communicate with communication network 100. Mobile unit 121 preferably includes a subscriber identity module or subscriber identification module (SIM), which is an integrated circuit that securely stores the IMSI and the related key used to identify and authenticate subscribers on mobile unit 121.

Mobile unit 121 can be a mobile device, such as a cell phone or smart phone, but may alternately be a device or sensor in a Machine-to-Machine (M2M) communication, or the device or sensor of the Internet of Things (IoT).

Mobile unit 121 is capable of accepting OTA SMS messages, for example OTA SMS messages from OTA server 111. Mobile unit 121 can preferably accept OTA SMS messages with the IMSI of mobile unit 121 in the destination address.

Mobile unit 121 is capable of processing OTA SMS messages and un-wrap the user data (UD) to retrieve the command of changing the device setting with a new telephone number, such as a new MSISDN/MDN. Mobile unit 121 preferably passes the command to the SIM/UICC located within mobile unit 121. The SIM/UICC card preferably has the capability to process the command and replace the existing old telephone number with a new telephone number.

The SIM/UICC preferably generates a proof of installation of the new telephone number and passes it to mobile unit 121. Mobile unit 121 then generates a new MO SMS with the proof embedded in the UD of MO SMS, and sends the MO SMS to OTA server 111 using the same message ID received from OTA SMS. Mobile unit 121 can then use the new telephone number as the originating address in the MO SMS.

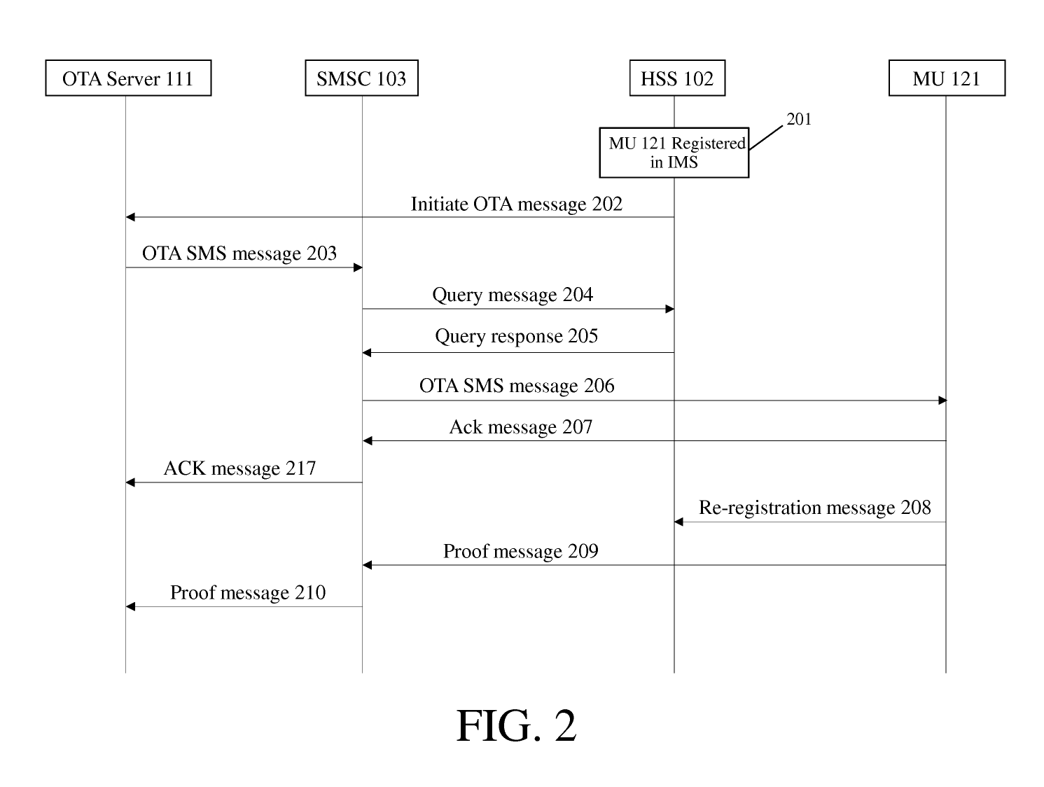

FIG. 2 depicts a call flow diagram 200 in accordance with an exemplary embodiment of the present invention.

When a new telephone number is associated with mobile unit 121 and mobile unit 121 has not yet changed the telephone number, mobile unit 121 needs to register (201) with communication network 100. This is preferably done using the IMSI of mobile unit 121, and can alternately be done using the old telephone number, either the MSISDN or MDN of mobile unit 121.

In accordance with an exemplary embodiment, an operator or subscriber requests to change the telephone number of mobile unit 121. The telephone number can be an MSISDN, an MDN, or any number that can be associated with a mobile unit and stored on a SIM card but that is distinct from the IMSI of the SIM card. The IMSI preferably does not change.

The operator provisions a new telephone number for mobile unit 121. This is preferably done in HSS/HLR database 102 associated with mobile unit 121. In an exemplary embodiment, the new telephone number is a new MSISDN that is different from the old MSISDN. In a further exemplary embodiment, the new telephone number is a new MDN that is different from the old MDN. In an exemplary embodiment, both the old telephone number and the new telephone number can both be present in mobile unit 121. For example, mobile unit 121 can include multiple numbers that will reach mobile unit 121 when dialed by another phone. In a first exemplary embodiment, HSS 102 allows multiple PUIDs. In a second exemplary embodiment, HSS/HLR 102 allows multiple MSISDN/MDNs per IMSI or multiple PUIDs per PRID. The old-MDN is preferably tagged as temporary.

In an exemplary embodiment, although the network system is updated with the new telephone number, mobile unit 121 registers with the network using the IMSI associated with their SIM card. In a further exemplary embodiment, mobile unit 121 registers with the network using the old telephone number.

After the network updates the new telephone number in the wireless system database, HSS/HLR 102 sends an Initiate OTA message 202 to inform OTA server 111 to initiate an OTA message, preferably an SMS message, to be sent to mobile unit 121 to change the telephone number of mobile unit 121 over the air. Alternately, OTA server 111 initiates the change on HSS/HLR 102 and will know directly about the successful completion of the telephone number change. In addition, end users or third parties may submit a request of changing or adding a telephone number via the Internet or via a smart phone application.

In an exemplary embodiment, OTA server 111 sends OTA SMS message 203 to mobile unit 121 using the IMSI of mobile unit 121 as the destination address. In an alternate exemplary embodiment, OTA server 222 utilizes the old telephone number as the destination address of mobile unit 121.

When SMSC 103 receives OTA SMS message 203, it preferably sends Query message 204 to HSS/HLR 102 for routing information using the IMSI of the SIM card in mobile unit 121. Alternately, SMSC 103 can use the old telephone number of mobile unit 121.

Upon receiving Query message 204, HSS/HLR 102 preferably checks the device profile and registration status utilizing the IMSI included in Query message 204. HSS/HLR 102 responds with Query response message 205 which preferably includes the routing information for mobile unit 121, for example the S-CSCF routing address of mobile unit 121.

The SMSC 103 utilizes the routing information to send OTA SMS message 206 to mobile unit 121, preferably by sending a SIP message. It should be understood that OTA SMS message 206 can traverse additional network elements not depicted in FIG. 2. For example, OTA SMS message 206 preferably traverses P/S-CSCF 104 prior to being transmitted to mobile unit 121.

OTA SMS message 206 is a new message type that includes an indication of the purpose of changing the MSISDN/MDN and that this change will be made via an over the air mechanism. The message type field is preferably included in the SMS message header, but can alternately be included in other fields, such as the message body payload. This allows the mobile unit to pass the over the air message to the SIM/UICC for an execution of changing the MSISDN/MDN directly. In an exemplary embodiment, the over the air message with this new message type is transparent to the end user of mobile unit 121.

In accordance with an exemplary embodiment, a SIM/UICC card in mobile unit 121 adds a new telephone number to mobile unit 121. The new telephone number is preferably a new MSISDN.

Mobile unit 121 sends acknowledgement message 207 to SMSC 103. The acknowledgement message preferably includes the old telephone number of mobile unit 121 registered with the old telephone number. Alternately, acknowledgement message 207 includes the IMSI of the SIM card in mobile unit 121 if mobile unit 121 registered with the IMSI.

SMSC 103 sends ACK message 217 to OTA Server 111 to alert OTA Server 111 that OTA SMS message 203 was properly sent to and received by mobile unit 121.

The SIM card in mobile unit 121 processes OTA SMS message 206 and stores the new telephone number in memory.

In accordance with an exemplary embodiment, mobile unit 121 sends re-registration message 208 to HSS 102 to re-register with HSS/HLR 102 with the new telephone number.

In accordance with an exemplary embodiment, mobile unit 121 sends proof message 209 to OTA server 111. Proof message 209 preferably is a Proof of Receipt (PoR) SMS message that includes an originating address field that includes the new telephone number. The originating address is preferably the IMSI of mobile unit 121, but can alternately be the new MDN or MSISDN of mobile unit 121.

In accordance with an exemplary embodiment, when OTA server 111 receives proof message 209 with a successful phone number change, OTA server 111 triggers telephone number entry changes in network based address books and location services which have the old telephone number of that mobile unit.

SMSC 103 sends proof message 210 to OTA server 111. Proof message 210 preferably includes a user message reference field which OTA server 111 can use for correlation. The user message reference field can be, for example, the message identifier.

OTA server 111 receives proof message 210 and preferably correlates it with the OTA SMS. OTA server 111 also confirms that mobile unit 121 has successfully installed the new telephone number.

In accordance with an exemplary embodiment, when HSS 102 sees a registration for a mobile unit with the new telephone number, HSS 102 automatically deletes the old telephone number if it is tagged as temporary. HSS 102 can also trigger number entry changes in network-based address books which have the old telephone number of mobile unit 121.

In the case where the mobile unit re-registration fails, the mobile unit preferably reinstalls the old telephone number, such as the MDN, and registers with the MDN. Alternately, the mobile unit can register with the IMSI. The mobile unit also preferably sends an SMS with the old-MDN or IMSI in the originator address, so the OTA-server knows that the update failed, and can re-try at a later time.

While this invention has been described in terms of certain examples thereof, it is not intended that it be limited to the above description, but rather only to the extent set forth in the claims that follow.

We claim:

1. A method for changing the telephone number of a mobile unit, the method comprising:
receiving an over the air message at the mobile unit, the over the air message including a new telephone number; and
changing the telephone number of the mobile unit to the new telephone number.

2. A method for changing the telephone number of a mobile unit in accordance with claim 1, wherein the over the air message is an SMS message, and wherein the new telephone number is embedded in the user data portion of the SMS message.

3. A method for changing the telephone number of a mobile unit in accordance with claim 1, wherein the step of changing the telephone number of the mobile unit comprises changing the telephone number of the mobile unit in a SIM card located within the mobile unit.

4. A method for changing the telephone number of a mobile unit in accordance with claim 1, wherein the step of changing the telephone number of the mobile unit comprises changing the MSISDN of the mobile unit.

5. A method for changing the telephone number of a mobile unit in accordance with claim 1, the method further comprising the step of sending a re-registration message from the mobile unit.

6. A method for changing the telephone number of a mobile unit in accordance with claim 5, the method further comprising the step of, in the case where the mobile unit re-registration fails, reinstalling the old telephone number.

7. A method for changing the telephone number of a mobile unit in accordance with claim 1, the method further comprising the step of sending a proof message by the mobile unit.

8. A method for changing the telephone number of a mobile unit in accordance with claim 7, wherein the proof message is an SMS message.

9. A method for changing the telephone number of a mobile unit in accordance with claim 7, wherein the proof message comprises the new telephone number.

10. A method for changing the telephone number of a mobile unit in accordance with claim 7, the method further comprising the step of making a telephone number entry change in a network based address book.

11. A method for adding a new telephone number to a mobile unit, the method comprising:
receiving an over the air message at the mobile unit, the over the air message including a new telephone number; and
adding the new telephone number to the mobile unit.

12. A method for adding a new telephone number to a mobile unit in accordance with claim 11, the method further comprising the step of deleting the old telephone number of the mobile unit.

13. A method for adding a new telephone number to a mobile unit in accordance with claim 12, the method further comprising the step of deleting the old telephone number if it is tagged as temporary.

14. A method for adding a new telephone number to a mobile unit in accordance with claim 11, wherein the over the air message is an SMS message, and wherein the new telephone number is embedded in the user data portion of the SMS message.

15. A method for adding a new telephone number to a mobile unit in accordance with claim 11, wherein the step of adding the new telephone number to the mobile unit comprises changing the MSISDN of the mobile unit.

16. A method for adding a new telephone number to a mobile unit in accordance with claim 11, the method further comprising the step of sending a re-registration message from the mobile unit.

17. A method for adding a new telephone number to a mobile unit in accordance with claim 11, the method further comprising the step of sending a proof message by the mobile unit.

18. A method for adding a new telephone number to a mobile unit in accordance with claim 17, wherein the proof message is an SMS message.

19. A method for adding a new telephone number to a mobile unit in accordance with claim 17, wherein the proof message comprises the new telephone number.

20. A method for adding a new telephone number to a mobile unit in accordance with claim 17, the method further comprising the step of making a telephone number entry change in a network based address book.
